(19) United States
(12) Patent Application Publication
(10) Pub. No.: US 2005/0112256 A1
(43) Pub. Date: May 26, 2005

(54) Method and apparatus for harvesting, washing, and drying cut vegetables and produce

(76) Inventors: Josh Mitchell, Monterey, CA (US); Stephen F. Griffin, Monterey, CA (US)

Correspondence Address: John W. Carpenter;REED SMITH CROSBY HEAFEY LLP, Suite 2000, Two Embarcadero Center, San Francisco, CA, 94111, US

(21) Appl. No.: 10/721,583

(22) Filed: Nov. 24, 2003

(51) Int. Cl. A01J 1/00

(52) U.S. Cl. 426/518

(57) ABSTRACT

Produce is harvested and de-cored in a field where they are grown. The de-cored produce is loaded in totes and transported to a processing facility. The processing facility includes a washing device that immerses the de-cored ends of the produce in a tank of washing fluid (e.g., a cleaning solution that includes anti-bacterial agents). In one embodiment, a flow of washing fluid is directed through the de-cored end of the produce and out a leafy end of the produce while the produce is still loaded in totes. A washing device having a tank and a transport mechanism that moves totes loaded with de-cored produce into the tank. Optionally, a device such as a pump maintains a flow in the tank in a direction toward de-cored ends of produce.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of Invention

The present invention relates to harvesting and preparation of vegetables and other produce. More particularly, the present invention relates to methods for harvesting, washing, drying, and packaging of produce.

2. Discussion of Background

In the field produce and particularly vegetables are typically harvested or gathered and placed into containers called baskets, totes, crates, cartons, or bins (hereafter collectively referred to as “baskets”) for further processing. Such baskets can be relatively small and capable of being lifted and otherwise manually manipulated by a single worker or they can be of a size which can only be lifted by a machine. The produce is sometimes placed in these baskets in a random orientation and is sometimes stacked into the baskets in a uniform orientation. In either case, the produce is not processed further in the field packing baskets and is merely transported to a central location where they are removed from the baskets and processed, i.e., washed, dried, packaged (e.g., bagged salads), cooled, stored, and then shipped.

As a result of the above processing, produce undergoes a significant amount of handling during the period of time from which it is first harvested until it is finally displayed for sale. This transferring of the produce from machine to machine and container to container can result in significant damage and degrading of the produce and makes it less appealing to the consumer visually. In addition, the shelf-life of produce is also reduced when it has been subjected to excessive handling. Moreover, cellular damage to produce in turn results in the loss of cellular fluids and in an increased risk of microbiological decay. Furthermore, the lengthy process of repetitive transferring of produce among various containers and various machines expends a significant amount of time and labor, thereby increasing its eventual cost.

Mitchell et al. I, 5,992,042, the contents of which are incorporated herein by reference, discloses a dryer device that efficiently dries washed vegetables. And, Mitchell et al. II, U.S. Pat. No. 6,112,429, the contents of which are incorporated herein by reference, discloses significant advances in the processes of field harvesting, cleaning, and drying of vegetables. Each of these inventions address many of the issues discussed above.

### SUMMARY OF THE INVENTION

The present inventors have realized the need to provide better cleaning, packaging, and drying of harvested vegetables. The present invention provides techniques for preparing vegetables for the washing, packaging, and drying processes. The techniques include removing a core of the harvested vegetable. The present invention allows for produce to retain its whole head structure or single leaf form, except for the de-cored end. The produce is field packed and maintained in totes for transport, washing, and drying, and packing (for both Retail and Foodservice produce) allows the product to be cleaned, dried and packaged while maintaining the whole head structure. This reduces costs and provides a cleaned product, and reduces retailers handling costs compared to other preparation techniques.

The whole head form saves having to reassemble the heads further reducing costs. The lengthy process of repetitive transferring of produce among various containers and various machines expends a significant amount of labor, (and causes shrinkage of the raw product) thereby increasing costs and reducing quality.

Core removal is preferably performed in the field during a harvest, but may be applied at another time or location such as a processing plant. The de-cored vegetable is subjected to washing fluid that cleans the vegetable as it flows through the vegetable (e.g., entering at the de-cored end and exiting a leafy end, and/or entering and exiting the de-cored and leafy ends of the produce during any of wash, rinse, and drying cycles).

The present invention includes a washing device that takes advantage of the physical characteristics of a removed core vegetable or produce by directing a flow of washing liquid through the core end into the vegetable for thorough cleaning and disinfecting. The present invention includes an entire process from harvest, through cleaning, and drying of the vegetable and packaging. The packing is accomplished by loading whole de-cored head vegetables or produce into a package (e.g., produce bag). In one embodiment, retail bags are loaded from the side with a reclosable zipper on the opposite side. The zipper is optional. The retail bags are loaded from the side instead of from the bottom. This is accomplished by a preformed loading devise that assists in sliding the product into a retail bag. The device holds the bag open while allowing the head to side into the bag. Foodservice is loaded by placing the bag over a ring. The ring holds the bag open during loading. Both Foodservice and retail bags have controlled atmosphere properties, which helps to extend the shelf life of the produce. The end result is a cleaner more healthy product having better consumer appeal and longer shelf life. The end result provides a ready to use whole de-cored heads or leaves in a sealed bag.

In one embodiment, the present invention is a wash device for washing cut vegetables in totes, comprising, a wash tank, a flow device configured to cause a flow of liquid through the tank, and a transport mechanism configured to place totes containing cut vegetables in the wash tank, wherein the transport mechanism is configured to move the totes through the wash tank in a pre-determined alignment direction, and the pre-determined alignment direction comprises an axial direction in which cut vegetables are to be located in the totes.

The present invention is embodied as method, comprising the steps of, cutting a product from a stalk from which it was grown, removing a core of the product, and placing the de-cored product in a tote in a pre-aligned direction relative to the tote, while maintaining the whole de-cored head structure.

The present invention also includes a method, comprising the steps of, cutting a product from a stalk from which is was grown, removing a core from a core end of the product, pre-washing the de-cored end of the product, loading the de-cored product in a tote in a pre-aligned direction relative to the tote, transporting the tote to a processing facility, washing the tote in a washing fluid, and spin drying the washed de-cored product in the tote. In one embodiment, the de-cored product is immersed in a tank of the washing fluid. In another embodiment, the de-cored product is subjected to a spray or a flow of washing fluid that has sufficient strength to cause at least some of the washing fluid to flow through the de-cored end and out a leafy end of the produce. The tote includes openings large enough to allow the flow of washing fluid and small enough to secure the produce in the tote. The washing fluid preferably comprises water and at least one of chlorine and anti-bacterial agents, and the step of washing comprises loading the tote on a transport mechanism configured to transport the tote through the tank of washing fluid.

Portions of both the wash device and method may be conveniently implemented in programming on a general purpose computer, or networked computers, and the results may be displayed on an output device connected to any of the general purpose, networked computers, or transmitted to a remote device for output or display. For example, the wash device may include electronic sensors for flow rates, and quality monitoring that are fed to a computer that sends control signals that increase or decrease flows, or add fresh water or anti-bacterial agents to the washing liquid.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a flow chart of a process according to an embodiment of the present invention;

FIG. 2 is a drawing of an exemplar tote according to an embodiment of the present invention;

FIG. 3 is a flow chart of a process according to another embodiment of the present invention;

FIG. 4A is a perspective view of an example tote according to an embodiment of the present invention;

FIG. 4B is a 4 view drawing of the example tote 400 loaded with cut de-cored produce according to an embodiment of the present invention;

FIG. 5 is a drawing of a wash tank according to several embodiments of the present invention;

FIG. 6A is a longitudinal view of a spray wash tank according to an embodiment of the present invention;

FIG. 6B is a longitudinal view of a flow wash tank according to an embodiment of the present invention;

FIG. 7A is a top view of a trough flow wash tank according to an embodiment of the present invention;

FIG. 7B is a top view of a wash tank having a flow counter to a direction of travel of a tote according to an embodiment of the present invention;

FIG. 8A is a drawing of a washing device according to an embodiment of the present invention;

FIG. 8B is a loaded tote according to an embodiment of the present invention;

FIG. 8C is an illustration of another embodiment of the present invention utilizing a dual wash tank;

FIG. 8D is an illustration of a loading end of a wash tank according to an embodiment of the present invention;

FIG. 8E is an illustration of a transition portion of a dual wash tank according to an embodiment of the present invention;

FIG. 8F is an illustration of a finishing end of a wash tank according to an embodiment of the present invention; and

FIG. 8G is an illustration of tote 200 loaded according to the preferred embodiment of the present invention.

### DESCRIPTION OF THE PREFERRED EMBODIMENTS

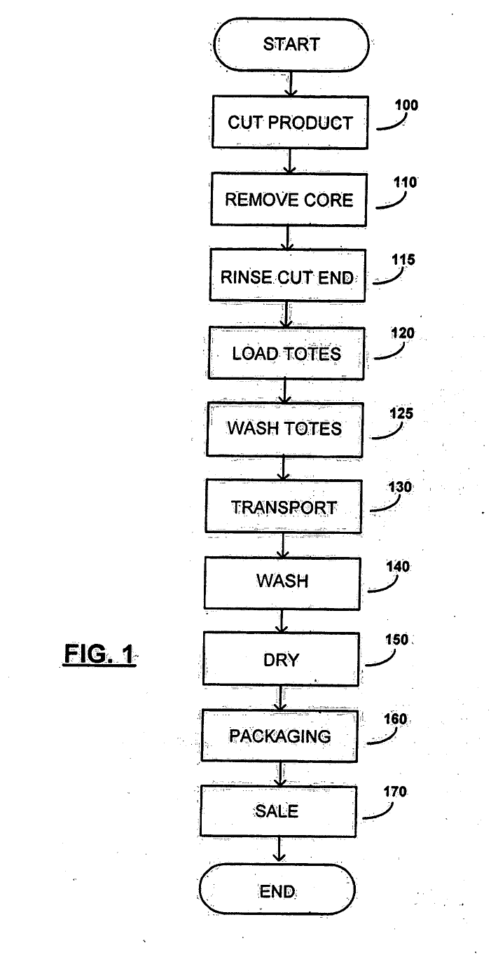

Referring now to the drawings, wherein like reference numerals designate identical or corresponding parts, and more particularly to FIG. 1 thereof, there is illustrated a flow chart of a process according to an embodiment of the present invention. The flow chart of FIG. 1 relates to produce such as lettuces, leafy vegetables, whole head and other vegetables, which will sometimes, collectively be referred to as any of “produce,” “products,” and/or vegetables throughout the disclosure. By “leafy vegetables” it is meant that family of Green leaf, Romaine, Red leaf, and the like. The present invention is also applicable to broccoli, cauliflower, and the like. Although the above describes several preferred produce for which the invention is applied, the invention may be applied to any other type of produce, vegetables, or other products that would benefit from the processes or equipment described herein.

At step 100, a produce item is cut from the stalk or plant from which it is grown. The cut product includes a butt, or core end, which begins at the cut portion and extends toward a generally leafy or open end of the product. The core is removed (step 110), for example, by using a stainless steel knife (e.g., a plug cutter having a tubular blade of a diameter approximately the size of an average outer core for the harvested product. The core may also be removed via a water knife, saw (e.g., Stainless Steel Saw) or other tools and the like. The core may be removed by a coring device or by cutting off the core across the bottom of a whole head produce. The de-coring can also be done by v-cutting the butt out of the produce. The de-cored product may also be topped (a cutting off of the top leaves of the produce) to remove any defects on the upper part of the leafs. The core and any topping is left to return to the soil. The cut end of the product is rinsed (step 115). The de-cored product is loaded into a tote with the cut de-cored ends of the product facing a pre-aligned direction within the tote (step 120), and then the product is washed in the totes (step 125). In one embodiment, discussed in more detail later, the de-cored product is loaded into the totes with the de-cored ends facing away from the center of the tote, in a outward direction.

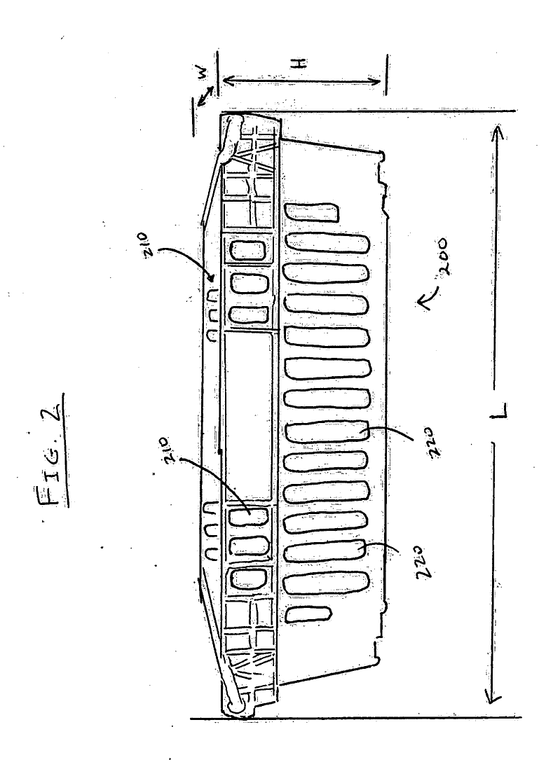

FIG. 2 is an example tote 200 that may be utilized for packing the cut de-cored produce. The tote is approximately the same size (height and width) as an average produce product to be fitted in the tote, so that at least one row of a produce product may be loaded into the tote. The tote includes slots 210, and 220 that will provide for free flow of washing fluid through the totes and vegetables contained therein. Dimensions are preferably Length (L) 24″, Height (H) 7″, and Width (W) 19 and ⅞″. The tote bottom is a grated surface that allows for easy draining of cleaning solution out of the tote. In one embodiment, the totes are, for example, a standard sized tote (e.g., a tote such as a mini-tote). However, the processes and washing devices presented herein are able to handle totes of various sizes.

The present inventors have determined that the manner in which the de-cored produce (e.g., heads packed in the tote increases the effectiveness of the wash). Preferably, heads are packed closely enough to prevent them from moving around but still allow flow of fluid through the product. This also allows for proper drying and more efficient unloading of the product when being packed.

Although the de-coring process is preferably performed in the field, it should be noted that the produce may be first loaded into the tote and then de-cored at a processing plant. However, such embodiments may require additional handling of the product that would likely increase cost and damage to the product.

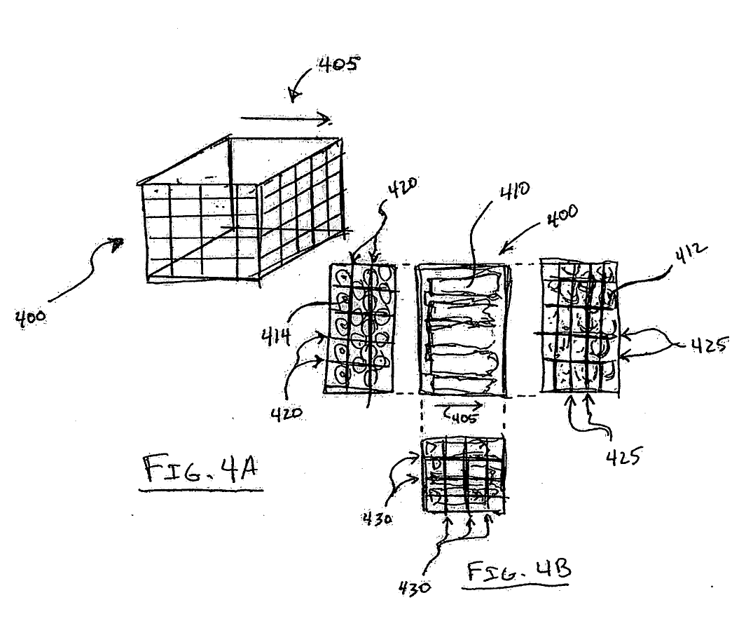

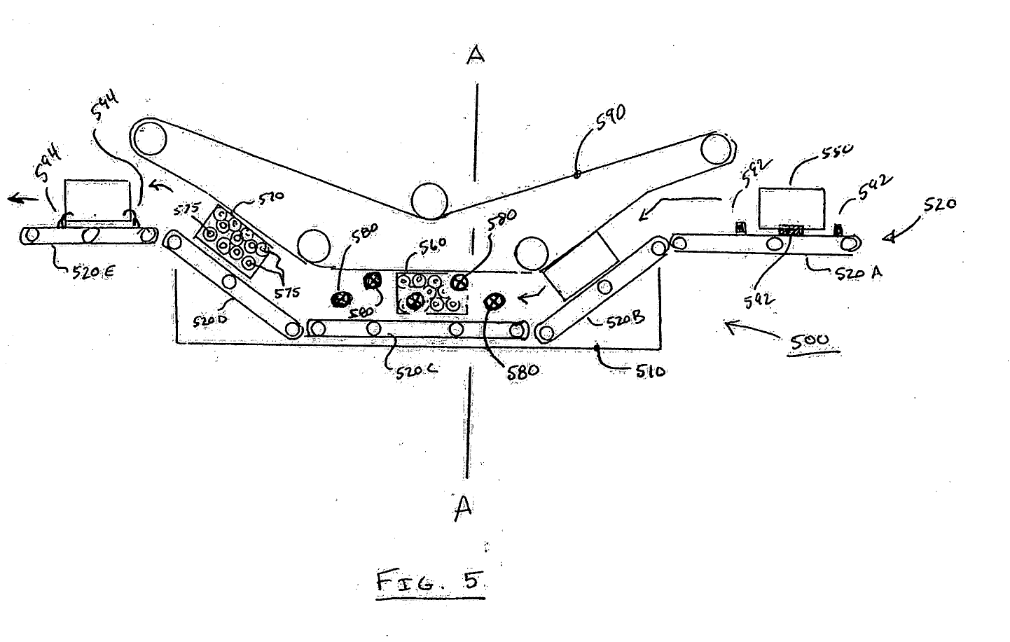

At step 130, the totes, having been loaded with cut de-cored vegetables, are transported from the field to a processing plant for washing, drying, and packaging. The washing process (step 140) is performed by placing the totes in a wash tank in an orientation with the pre-aligned direction so that a flow of washing fluid in the tank (relative to the tote) is directed toward the cut and de-cored ends of the produce. Thus, when the cut de-cored vegetables are set in a pre-aligned direction in the totes (as shown in FIG. 4B, the pre-aligned direction is along an axis of the vegetables), the flow of washing fluid relative to the tote causes the washing fluid to impact the vegetables at the cut de-cored ends. The result is that the washing fluid tends to travel through the vegetable (e.g., entering at the de-cored end and exiting at or between the individual leafs of a leafy end of the produce), resulting in a cleaner fresher product. The washing fluid (washing solution) itself is preferably chilled water treated with an anti-bacterial agent. The chilled water is provided through a water chiller that cools the produce eliminating the need for any additional cooler, thus extending shelf life and reducing costs. Other embodiments of washing fluid include basic tap water or another solution.

As noted in Mitchell et al. II, more than one washing tank may be utilized, each tank having a different solution or other environmental characteristics. Any of the features in either Mitchell et al. I or Mitchell et al. II may also be applied to processing according to the present invention. Spray mechanisms may be placed between washing tanks to further clean the produce. In one embodiment, the tanks include different cleaning solutions (e.g., a chilled tap water wash and a separate chilled anti-bacterial solution at different temperatures).

A dwell time in which the produce is exposed to or immersed in the chilled solutions controls a temperature of the produce. The temperature of the produce is regulated as needed so that additional cooling is not needed. In several embodiments, equipment used to process the produce, and particularly the temperature of the washing fluid, is set to achieve and maintain the product in a temperature range that extends a shelf life of the product. For example, the temperatures of the water, equipment, and/or environment (e.g., ambient air temperature, conveyors, spin dryer, etc.) achieve a product temperature of approximately 33-38 degrees F.

In one embodiment, the totes are immersed in a wash tank without any special flow arrangements. The de-cored ends facilitate flow of water into previously enclosed or partially enclosed portions of the produce and allows the produce to “open” (spread the leafy portions apart). Additional cleaning flow occurs as the washing fluid splashes and eddies within and against the produce, and even more so when the washing fluid drains from the produce. As noted above, multiple tanks may be utilized with sprayers (spray bars) between tanks. (alternatively, a tote can be routed more than once through a single tank). Repeatedly immersing, draining and spraying of the de-cored produce provides for sufficient cleaning solution flow to provide a very clean product.

At step 150, the totes are loaded into a dryer. Preferably the dryer is a spin dryer similar in construction to that described in Mitchell et al. I, however, other dryers may be utilized. The totes are taken from the washing line and preferably loaded into the spin dryer so that an open end of the produce in the totes is facing outward (i.e., centrifugal forces push excess water out through the leafy end, if any, of the produce). The centrifugal force of the spin dryer is more effective with the de-cored produce compared to intact core produce because of easier flow through the vegetable (e.g., there is less vacuum holding water to the produce because the cut end can produce an open channel). Due to the greater efficiency of spin drying de-cored produce, the dryers may be run at a slower rpm compared to drying operations on cored produce (increasing the dryers' useful life and decreasing energy consumption). Optionally, the spin speed or cycle times of the drying operations may be reduced. After drying, the products are packaged (step 160) and then sold/delivered to a customer (step 170).

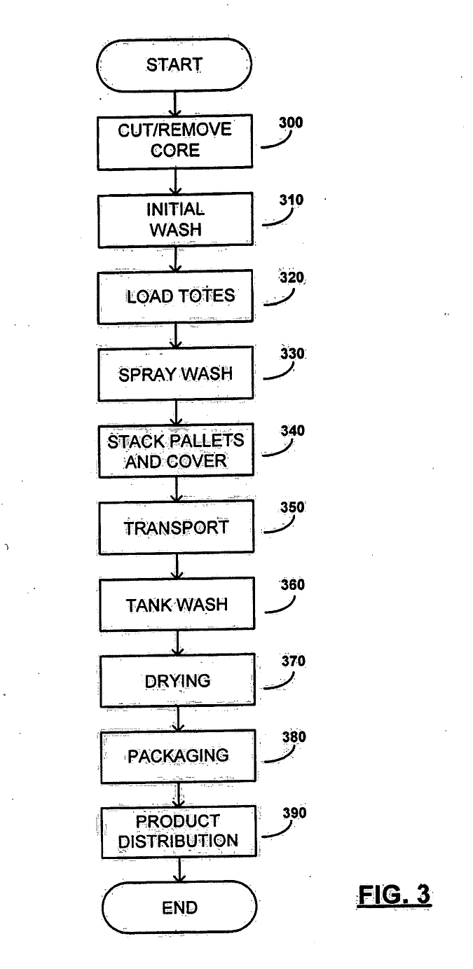

FIG. 3 is a flow chart of a process according to another embodiment of the present invention. FIG. 3 elaborates on some optional, but preferred details of the process described in FIG. 1. At step 310, after cutting and de-coring, an initial wash is performed. The initial wash is performed using a cleaning solution which comprises, for example, a mixture of water and chlorine. The initial wash can be performed via any of a handheld pressure sprayer, automatic spray nozzles (e.g., activated by a photo eye or motion sensor when a head is held over (or under/near) the nozzle), and/or by immersing the cut/de-cored produce in a bucket of the initial wash cleaning solution. The initial wash is intended to remove internal liquids exuding from the de-cored produce (e.g., the produce's “milk”) and to sanitize the produce.

At step 330, with the cut de-cored produce is loaded in totes, the totes are then loaded onto a field conveyor belt and sprayers mounted around the conveyor belt perform a spray wash on the core and leafy ends (tops) of the produce. The initial spray wash is, for example, a chlorine solution which cleans excess dirt and plant liquid (“milk”), and reduces browning and discoloration of the produce.

At step 340, the totes are loaded onto a field trailer (preferably on pallets on the trailer). The field trailer provides for temporary storage and allows for larger bulk pickups of the loaded totes. On the field trailer, the loaded totes are covered (e.g., an opaque cover that protects from sunburn, windburn (particularly during transport), and keeps out dust and other foreign particles, reduces dehydration.). In one embodiment, the cover is a white plastic shroud strapped to the totes.

Again, the loaded totes are transported to a processing plant for washing, drying, packaging, and product distribution (steps 350, 360, 370, and 390).

Turning now to the washing process. The produce are placed in a pre-aligned direction in the totes. FIG. 4A is a perspective view of an example tote 400. FIG. 4B is a 4 view drawing of the example tote 400 loaded with cut de-cored produce 410. The de-cored produce 410 is loaded into the tote 400 in a pre-aligned direction 405. The pre-aligned direction 405 is a direction of a flow of washing fluid that will be applied to the tote. The pre-aligned direction 405 is, for example, an axial direction (an axis from the core to leafy ends of the produce) in which the de-cored produce is to be located in the totes.

As shown in FIG. 4B, the de-cored produce 410 is loaded in the tote such that a de-cored end 414 of the produce are facing the flow. A leafy end 425 of the produce is away from the flow.

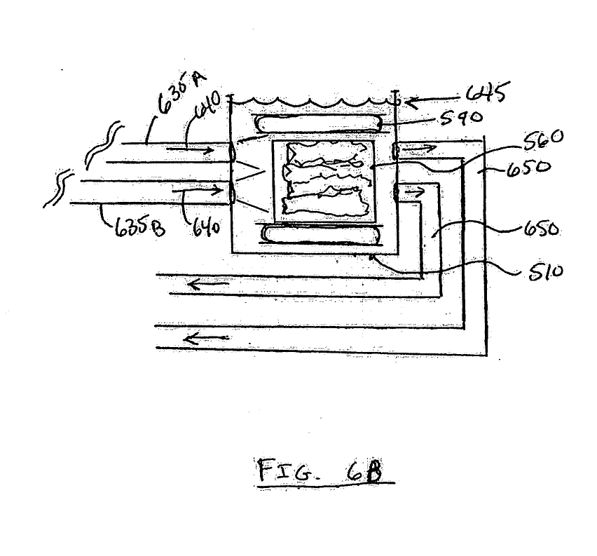

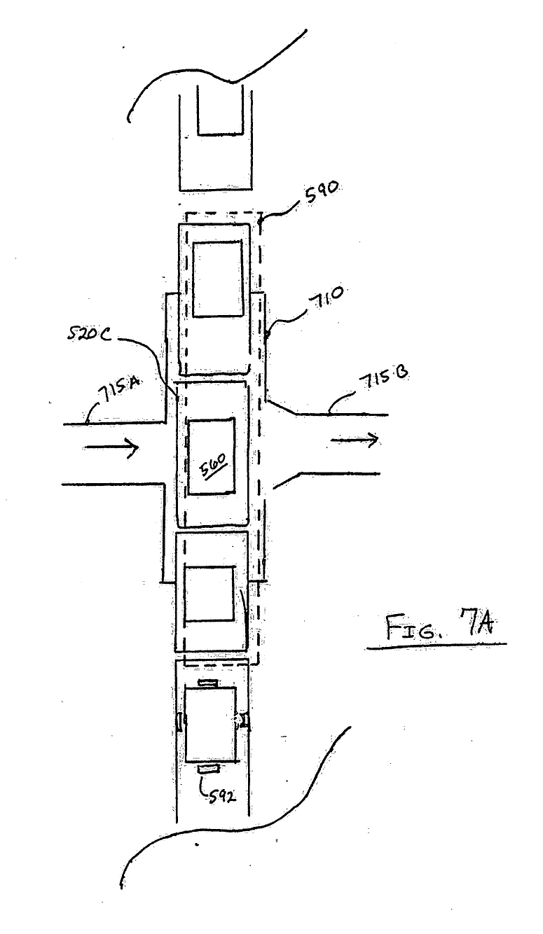

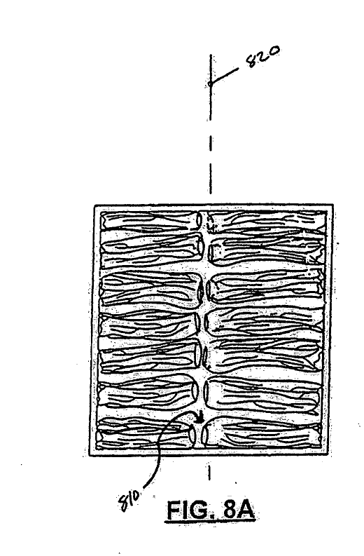

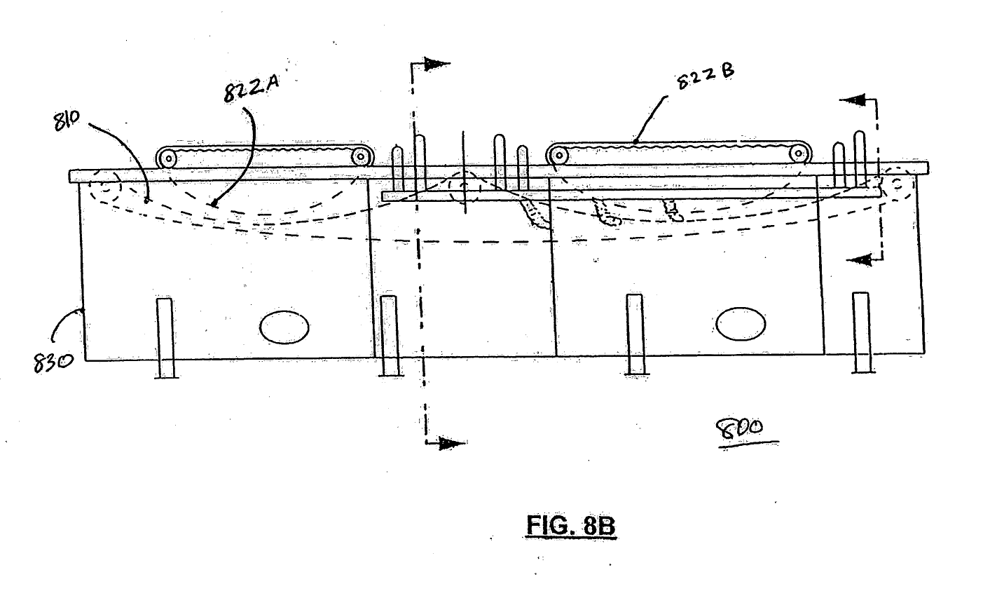

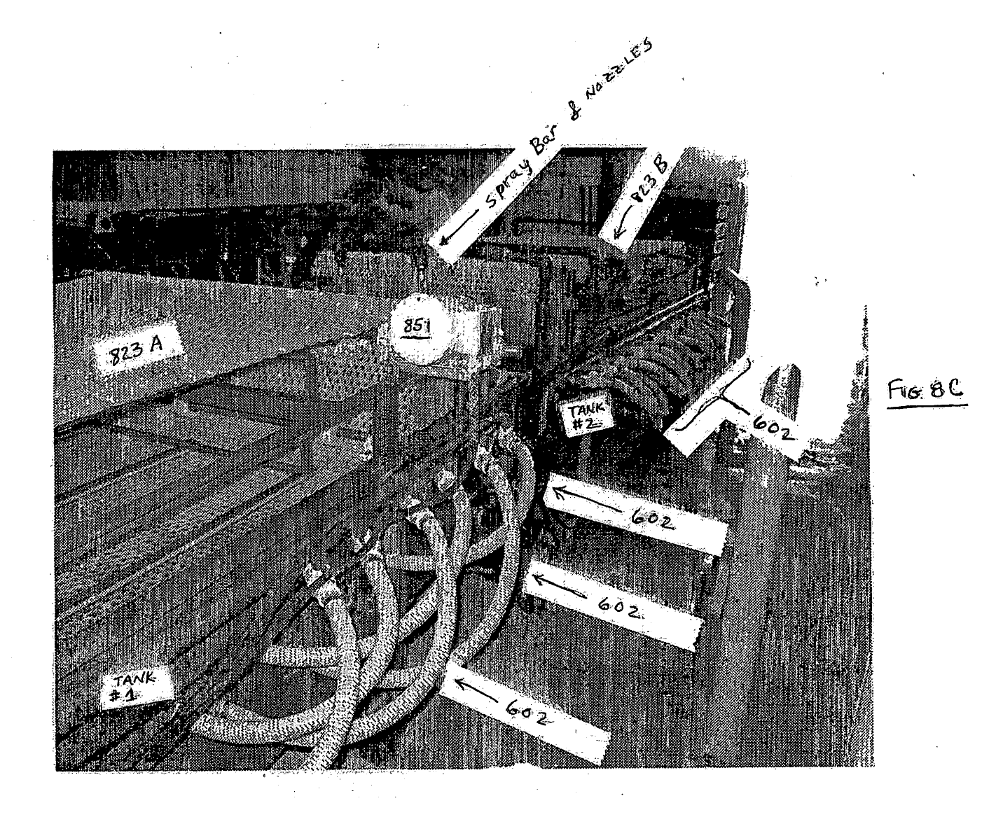

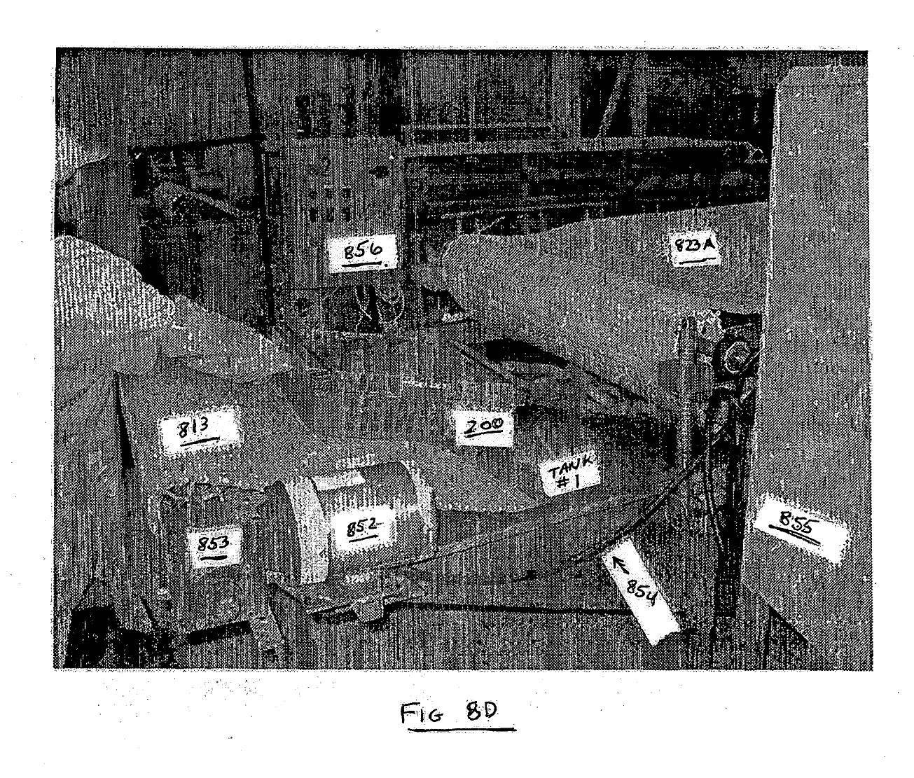

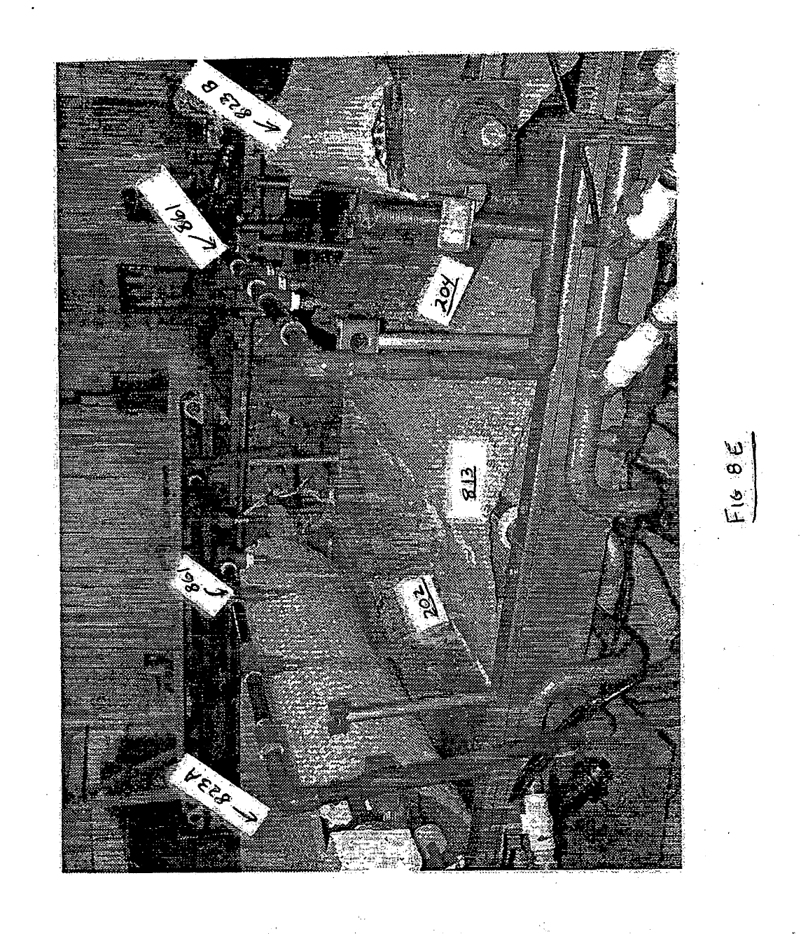

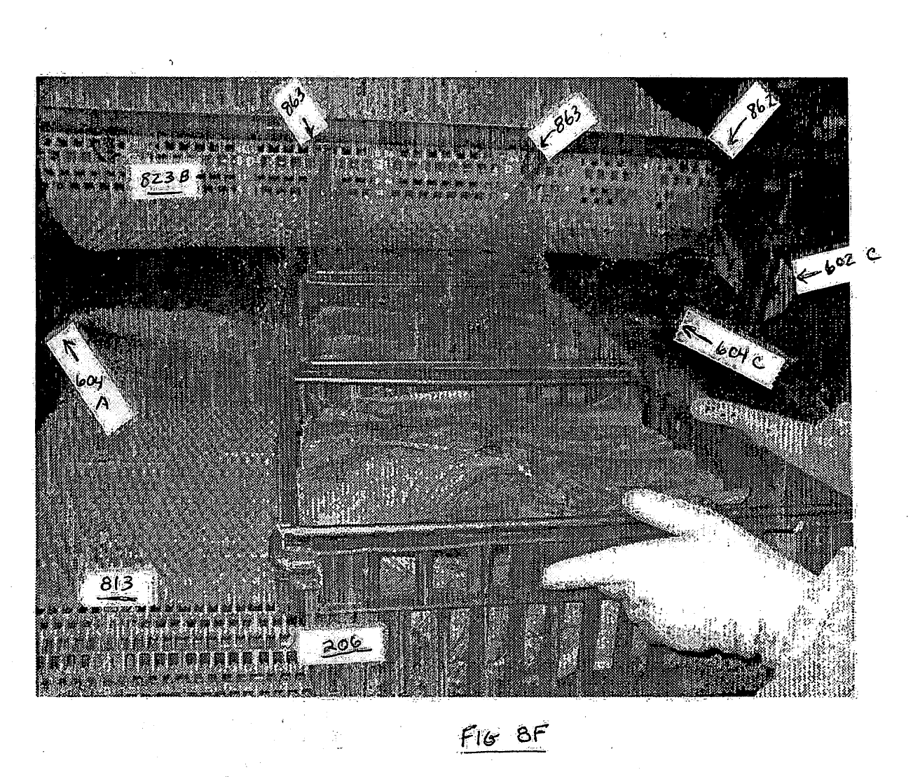

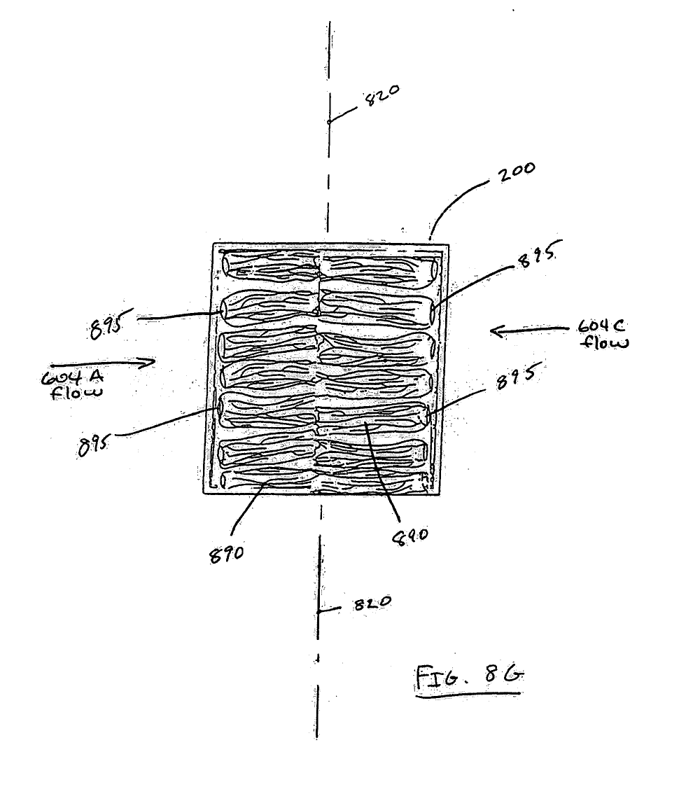

Although the present invention is preferably implemented with flows impacting each side of the tote (e.g., FIGS. 6A and 8G), in one embodiment, the tote 400 is designed for maximum flow through the tote in a single direction. Gratings 420 on a side of the tote facing the flow are spaced further apart (openings are larger) than gratings 425 on a side of the tote away from the flow. The larger grating openings facing the flow provide greater access for washing fluid ejected from spray nozzles, flow pipes, or through channels, that directly impact the de-cored ends. The smaller grating opening on the side of the tote away from the flow provides better support for the leafy ends of the produce and help prevent the produce or portions of the produce from being forced out of the tote due to pressure from impact of spray or other washing fluid flows. The gratings may also be referred to as a venting pattern. The approximate size and shape of the totes and venting patterns may vary. For example, the totes may have one or more standard venting patterns evenly distributed on sides, tops, and bottoms of the totes. Other venting patterns, including multiple tote venting patterns may be utilized.

The whole head form of the produce also helps keep the produce in the tote during washing and drying, and makes it easier to remove from the tote for packing, either clam shell or bags. The whole head form can generally be described as a vegetable or produce in which a head (e.g., leafy portion of the vegetable remains together even though the core portion of the vegetable has been removed). FIG. 8G is an example of a tote loaded with produce in whole head form (or whole head concept) that is applicable to various of the embodiments described herein.

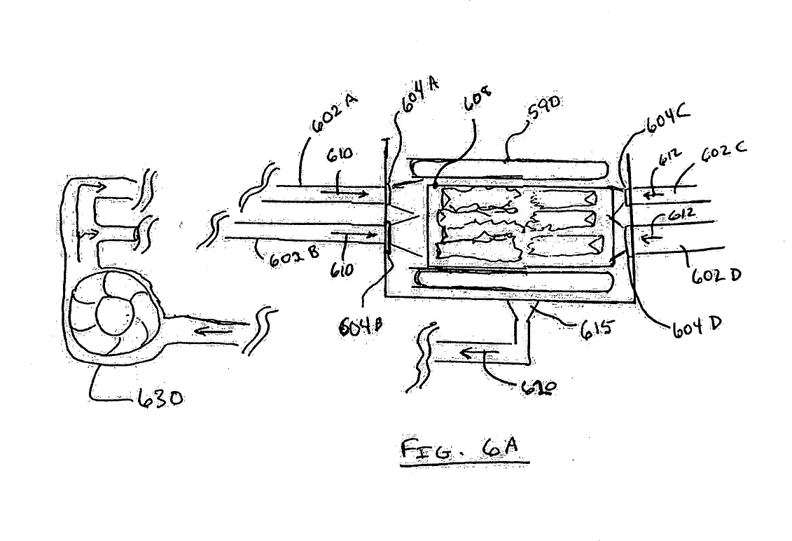

FIG. 5 is a drawing of a washing device 500 according to several embodiments of the present invention. The washing device 500 includes a tank 510 and a transport mechanism 520. The tank is, for example, a stainless steel water tight tub with appropriate fittings for cleaning, draining, introduction of washing fluid, and, as discussed in several embodiments, for maintaining a flow of washing fluid through the tank. Many other materials are suitable for the tank construction, including, but not limited to plastics, other metals, fiberglass, etc.).

The transport mechanism 520 is, for example, as illustrated in FIG. 5, a conveyor belt. The conveyor belt, as illustrated in FIG. 5, may be segmented (e.g., segments 520A-520E), or may be a single loop. The transport mechanism may also be constructed as a pull line (e.g., chain or rope) having latches configured to hook onto the totes and drag them through the wash tank 510 (ramps in the wash tank would then direct the totes into and out of the wash tank along a line where they are processed).

De-cored ends 575 of produce are illustrated in tote 570. A flow of washing fluid through the tank 510 is shown by the circled x's 580 (indicating a flow of washing fluid into the page of the drawing). The flow of washing fluid is consistent with the pre-aligned direction that produce was loaded into the totes, the de-cored ends 575 are facing flow of the washing fluid, and leafy ends 675 of the produce (not shown in FIG. 5) are away from the flow.

In one embodiment, the totes are open at a top of the totes. To prevent produce from floating out of the totes (or being expelled due to the flow of washing fluid, a top conveyor belt 590 rides on top of the totes. The top conveyor belt also helps maintain registration of the totes to the lower conveyor belt(s) (520A-520E).

The present invention refers to registration, a term which is used to describe maintaining a position of a tote on the conveyor belt (or other transport mechanism). In the context of the present invention, registration is enough holding power (e.g., traction) to move the tote through the wash tank (preferably, the totes maintain a same position on the belt(s), but some slippage or movement relative to the belt(s) is permissible). The use of stops, latches, or other gripping mechanisms may also be used to maintain a relatively stable position on the transport mechanism.

In one embodiment, the bottom conveyor belt is a single loop. Stops 592 are placed on the conveyor belt and maintain registration of the totes with the bottom conveyor belt. In one embodiment, stops are replaced by latches 594 that hook onto the tote and maintain registration with the conveyor belt. The latches 594 also eliminate the need for the top conveyor belt to maintain registration. In one embodiment, the top conveyor belt 590 is not used and the totes are fitted with top (e.g., grated wire or plastic top—not shown) to prevent the produce from leaving the tote. Another embodiment involves the use of any gripping mechanism on the bottom belt such as raised rubber “grip” sections placed to catch the bottom edge of the tote. This is enough to maintain placement and forward motion of the totes.

Preferably, the speed of the conveyor belts are variable (e.g., computer controlled). Inverters control the speed of the conveyor motors. A control panel may, for example, be placed inside the cabinet to prevent worker tampering. The variable speed of the conveyor belt is used to control a “dwell time” or the duration of the products exposure to the wash fluid and jets. This increases the effective range of products and product conditions to be processed by the same production line. For example, for a heavily soiled product, the production line would be set or otherwise programmed for a longer dwell time. Less soiled or more easily cleaned products would be set for relatively shorter dwell times.

The size and shape of the tank 510 may take many different configurations. As noted above, ramps may be included in the tank to facilitate movement of totes through (e.g., entry into and exit from) the tank.

In several embodiments, the washing device also includes a flow device that maintains a flow of washing fluid through the tank. In FIG. 5, the flow is shown perpendicular to a direction in which the totes are traveling on the conveyor belt. The flow may be maintained in a direction parallel to the direction the totes are travelling, but then the pre-aligned direction within the tote is changed, or the totes are rotated 90 degrees relative to that shown in FIG. 5. For example, the flow may travel in a direction opposite the direction of travel of the totes. In the example case, the totes would be rotated (or produce aligned) 90 degrees from that shown so that the de-cored ends face the flow. In one embodiment, no flow is maintained in the wash tank and movement of the tote through the washing fluid creates a flow of washing fluid through the de-cored produce.

In one embodiment, the flow is created only from immersion of the tote in the wash tank. The de-cored and leafy ends of the produce “fill” with washing fluid by being immersed. Because the butt end of the produce has been de-cored, the flow, or “filling” of the produce with washing fluid is more efficient and effective compared with immersion of intact core produce. Likewise, and flows maintained in the tank or caused by motion of the tote through the wash tank are also more effective at cleansing the produce.

In one embodiment, the totes are loaded exactly as described in Mitchell et al. II except that the produce has been de-cored or otherwise processed (e.g., field processing) as described elsewhere herein. Tote loading for this embodiment is shown in FIG. 8A, with de-cored ends 810 of the produce facing the centerline 820. The loaded totes are then transported through a wash tank as described herein or as described in Mitchell et al. II. FIG. 8B is an example washing device 800 similar to that described in Mitchell et al. II. A distance between the de-watering belt 810 and top belt (822A or 822B) is adjusted so that totes (e.g., any of totes as shown in FIGS. 2, 4A, and 8A) fit securely between the belts, and movement of the belts cause the totes to be immersed and transports through the wash tank 830. Finally, the totes are loaded directly (without repackaging) into a dryer, which may be embodied as any of the dryers described in either Mitchell et al. I or Mitchell et al II, or other dryer devices.

Furthermore, variations in the direction and travel of the line (e.g., conveyor belt of FIG. 5) and hence changes in the orientation of the totes and produce contained therein may occur. In these cases, it is preferred that the flow (either as maintained in the wash tank or as created by the motion of the tote relative to the washing fluid), at least at some point during those changes in direction and travel of the tote, is directed toward the de-cored ends of the produce in the totes. However, although it is preferred to have proper orientations as described herein, it should be understood that the present invention still provides a cleaner product compared to existing washing systems regardless of the orientation of the totes, orientation of the product within the totes, or the presence of a flow in the wash tank.

For the various embodiments employing a flow of washing fluid, many different types and variations of flow devices may also be utilized. The flow device may be, for example, a pump, waterwheel, or other device capable of maintaining a flow of washing fluid. The present inventors have realized that pump sizing ensures wash effectiveness across all product densities. Larger pumps create more turbulence in the lines. An APV pump model #18vs2 has been determined to provide needed size capacity. The size is 7.5 hp. Other makes/models of pumps having similar capacities would also provide the same level of effectiveness.

Apparatuses and configurations in which the flow is applied to the totes may also take many forms. FIG. 6A is a longitudinal view of a spray wash tank according to an embodiment of the present invention. In FIG. 6A, input flow pipes 602A and 602B route a flow 610 of washing fluid into the wash tank 510. Nozzles 604A and 604B are fitted at ends of the input flow pipes and provide a spray pattern directed at produce loaded in totes. The spray pattern from nozzles 604A and 604B are directed toward cut de-cored ends of produce on the left side of tote 608.

Input flow pipes 602C and 602D route a flow 612 of washing fluid into the wash tank 510. Nozzles 604C and 604D are fitted at ends of the input flow pipes 602 C and 602 D and provide a spray pattern directed at produce loaded in totes. The spray pattern from nozzles 604C and 604 D are directed toward cut de-cored ends of produce on the right side of tote 608.

Placement of the nozzles is made to maximize flow of washing fluid through the whole head de-cored produce (e.g., directing nozzles toward the totes, and, more specifically, toward de-cored ends of produce in the totes). The de-cored ends 575 of the produce are facing the flow of the washing fluid.

A drain (or central sump) 615 is located, for example, at a center of the wash tank and collects washing fluid that has run off the produce and feeds a return flow 620 back to a pump 630 or other mechanism that maintains the flow 610. The return line may, for example, drain into a filter to remove debris washed from the produce. The washing fluid may also be directed to a holding area (e.g., holding tank) where maintenance of the washing fluid (e.g., testing, temperature maintenance, adding additional fluid, etc.) is performed.

FIG. 6B is a longitudinal view of a flow wash tank according to an embodiment of the present invention. In FIG. 6B, washing fluid is input to the washing tank 510 at a flow 640 of relatively high velocity. The washing fluid flow 640 may be directed toward the tote 560 via nozzles at the ends of pipes 635A and 635B, or, the pipes may be open. A fluid level 645 is maintained at or above the top of the totes.

In this embodiment, the washing force is not a spray directed at the de-cored ends, but instead is a flow of washing fluid (or other cleaning solution) directed across the washing tank 510 from an end of pipes 635A and 635B to return pipes 650.

Although shown as 2 example supply pipes and at least one return pipe are shown in the figures, both the supply and return pipes may be embodied as a single large pipe or any number of smaller pipes.

The flow is sufficient to enter the de-cored ends of the produce and, at least to some extent, flow through the produce. In flowing through the produce, an “opening” of the leafs or leafy end of the produce occurs. Sediment, contaminants, and other debris between the leafs are washed away with the flow. The return pipes are capable of the same or better flows as the input pipes 635A and 635B.

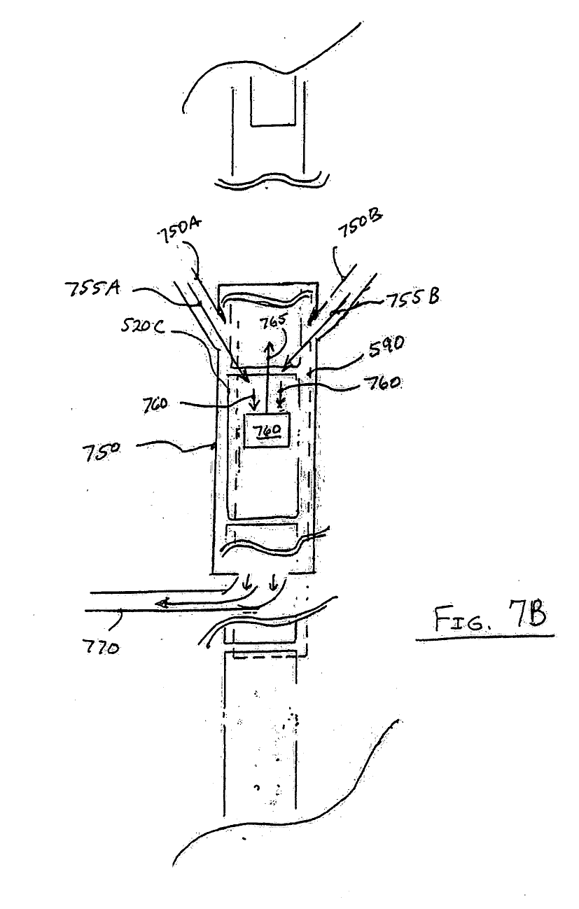

FIG. 7A is a top view of a trough flow wash tank according to an embodiment of the present invention. In FIG. 7, a wash tank includes a cross flow channel 715. The cross flow channel includes an input channel 715A and a return channel 715B. The cross flow channel provides a flow of washing fluid directed at de-cored ends of produce located, for example, in tote 560. The top conveyor belt 590 is shown in dotted outline so as not to obscure viewing of other features. In one embodiment, the entire wash tank is embodied as a cross flow channel (e.g., the cross flow channel in FIG. 7A is wide enough to accommodate a transport mechanism that immerses and retrieves the totes from the washing fluid.

FIG. 7B is a top view of a counter flow wash tank according to an embodiment of the present invention. A wash tank 750 is fitted with input supply lines (e.g., 750A and 750B) that provide an initial flow of washing fluid. In this embodiment, the initial flow of washing fluid enters the washing tank from both the left and right side of the tank. In other embodiments, the initial flow may enter the tank from one side of the tank, from above the tank, or from below the tank. Upon entering the tank, the initial flow is directed (e.g., via combination of the initial flows, and/or by the tank sides) toward the totes as flow 760. The flow 760 is preferably counter to a direction of travel 765 of the totes. The tote 760 is loaded with de-cored produce in an orientation such that the de-cored ends are facing the flow 760. The orientation of the de-cored produce may be accomplished, for example, by loading the totes perpendicular to that shown in the other figures, or, by loading the produce along a second pre-aligned direction in the totes. A return line 770 is fitted downstream from the input supply lines.

FIG. 8C is an illustration of another embodiment of the present invention utilizing a dual wash tank that directs a washing fluid flow at totes traveling through the tanks on conveyor belts. Top belts 823A and 823B maintain registration of totes traveling on a bottom conveyor belt 813 (not shown). Input flow pipes 602 are arranged on one side of both tanks. An electric motor 851 powers the top belts. A spray bar and nozzles are shown for cleaning the produce as it travels between tank #1 and tank #2.

FIG. 8D is an illustration of a loading end of a wash tank according to an embodiment of the present invention. Tote 200 is placed on a bottom conveyor belt 813, and is about to be immersed in tank #1. The tote will be held in registration with the bottom conveyor belt via top belt 823A. Electric motor 852 and gear box 853 provide rotary motion powering the bottom belt 813. Power and control lines from a control mechanism (not shown) installed in security cabinet 855 controls the speed of the bottom belt 813 and top belts 823A and 823B (e.g., dwell time adjustments). Emergency shut off and main power is, for example, provided at breaker box 856.

FIG. 8E is an illustration of a transition portion of a dual wash tank according to an embodiment of the present invention. Tote 202 is illustrated as emerging from tank #1 and tote 204 is illustrated as being submerged in tank #2, both totes riding on bottom belt 813. Spray bars with nozzles 861 further clean the produce as it travels between tanks.

FIG. 8F is an illustration of a finishing end of a wash tank according to an embodiment of the present invention. Tote 206 is being pulled off of the bottom belt 813. Spray bar 862 feeds nozzles 863 that spray the produce with a final cleaning solution. Nozzles 604A and 604C are shown providing a flow perpendicular to the direction of travel of the totes, each of the flows being directed towards the cut de-cored ends of produce loaded in the totes.

FIG. 8G is an illustration of tote 200 loaded according to the preferred embodiment of the present invention. Leafy ends of produce 890 is placed facing a centerline 820 of tote 200. The cut de-cored ends 895 of the produce are facing opposite sides of the totes in a position that places the cut de-cored ends directly in the path of flows from, for example, nozzles 604A and 604C. In this embodiment, the flow is directed in opposite directions toward both sides of the totes (toward a centerline of the belts) and each flow direction is perpendicular to a path of travel of the totes, thereby placing each de-cored part of the produce directly in the flows.

The present invention provides for various configurations and processes for harvesting, washing, and packaging produce. In at least one embodiment, the produce is washed in the field twice and once in a remote processing plant. The produce may be double washed at the processing plant. Any combination of the field and plant washing as described herein may be utilized. The end result is a de-cored product that has been cleaned “triple washed,” dried, and packaged ready for use.

Portions of the present invention may be conveniently implemented using a conventional general purpose or a specialized digital computer or microprocessor programmed according to the teachings of the present disclosure, as will be apparent to those skilled in the computer art. For example, sensor data monitoring washing fluid quality, temperature, and flow rates (e.g., sensors mounted in the holding tank) may be fed to a computer programmed to evaluate those factors and make adjustments as needed. The adjustments may include changing water, adding chlorine, anti-bacterial agents, preservatives, coloring, sealants, or other chemicals, and/or raise or lowering the washing fluid temperature. The adjustments may be made, for example, via valves having electronic controls coupled to programming (e.g., allow the release of fresh water and/or chemicals, open/close drains, for example), and switches that control flow of pumping devices and heating/cooling elements.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to control, or cause, a computer along with appropriate equipment infrastructure (wash tanks, transport mechanisms, etc) to perform any of the processes of the present invention. The storage medium can include, but is not limited to, any type of disk including floppy disks, mini disks (MD's), optical discs, DVD, CD-ROMS, micro-drive, and magneto-optical disks, ROMs, RAMs, EPROMs, EEPROMs, DRAMs, VRAMS, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

In describing preferred embodiments of the present invention illustrated in the drawings, specific terminology is employed for the sake of clarity. However, the present invention is not intended to be limited to the specific terminology so selected, and it is to be understood that each specific element includes all technical equivalents which operate in a similar manner. For example, when describing a flow mechanism, a mechanical pump is discussed and illustrated, however, and other alternate mechanism capable of causing a flow of liquid (e.g., compressed air driven pump) may be utilized. The invention includes any and all modifications needed to adapt the teaching described herein to work with alternate mechanisms. All other described items, including, but not limited to washing tanks, pumps, totes, conveyor belts, nozzles, supply and return pipes, drains, anti-bacterial agents, chlorines, washing fluids, etc should also be consider in light of any and all available equivalents.

Obviously, numerous modifications and variations of the present invention are possible in light of the above teachings. It is therefore to be understood that within the scope of the appended claims, the invention may be practiced otherwise than as specifically described herein.

1. A method, comprising the steps of:
cutting a product from a stalk from which is was grown;
removing a core of the product; and
placing the de-cored product in a tote.

2. The method according to claim 1, wherein said step of removing comprises cutting the core off.

3. The method according to claim 1, wherein said steps of cutting, removing, and placing are performed at one of in the field where the product was grown and at a processing plant prior to washing.

4. The method according to claim 1, wherein said steps of removing, and placing are at a processing plant.

5. The method according to claim 1, wherein a whole head nature of the product is retained.

6. The method according to claim 1, wherein said step of removing comprises cutting out the core of the product using a stainless steel knife.

7. The method according to claim 1, wherein said step of removing comprises cutting out the core of the product using a v-cut or other device for removing the core.

8. The method according to claim 1, further comprising the step of pre-washing the cut product prior to placing it in the tote.

9. The method according to claim 1, further comprising the step of spray washing at least one end of the product before placement in the tote.

10. The method according to claim 9, further comprising the step of spray washing the product after placement in the tote and prior to transfer to a transport vehicle.

11. The method according to claim 1, further comprising the step of cleaning the de-cored product in the tote by placing the tote in a flow of washing fluid such that de-cored ends of the product are facing the flow.

12. The method according to claim 11, wherein a whole head nature of the product is retained from harvesting through washing, drying, and packaging

13. The method according to claim 11, wherein the flow comprises a first flow directed at a first side of the tote and a second flow directed at a second side of the tote.

14. The method according to claim 13, wherein the step of placing comprises placing a first row of the de-cored product in the tote with de-cored ends of the product in the first row facing the first side of the tote, and placing a second row of the de-cored product in the tote with de-cored ends of the product in the second row facing the second side of the tote.

15. The method according to claim 13, wherein the de-cored product is placed in multiple rows on top of each other in the tote.

16. The method according to claim 1, further comprising the step of immersing the tote in a wash tank for cleaning.

17. The method according to claim 16, wherein the wash tank includes a flow of washing fluid.

18. The method according to claim 16, wherein the wash tank comprises a flow of washing fluid relative directed toward the de-cored ends of the product.

19. The method according to claim 16, wherein said step of immersing comprises loading the tote on a conveyance device that carries the tote through a wash tank.

20. The method according to claim 19, wherein the product is placed in the tote in an orientation such that the cut and de-cored ends of the product face a flow of washing fluid in the wash tank.

21. The method according to claim 1, wherein the product is oriented within the totes in a direction consistent with requirements of a spin dryer.

22. The method according to claim 11, further comprising the step of spin drying the product in the tote;
wherein a whole head nature of the product is maintained from harvesting through washing, drying, and packaging.

23. The method according to claim 22, wherein a temperature of the washing fluid and other equipment utilized in the washing, drying, and packaging achieves and maintains the product in a temperature range that extends a shelf life of the product.

24. The method according to claim 23, wherein a temperature of the washing fluid and other equipment utilized in the washing, drying, and packaging equipment achieve a product temperature of approximately 33-38 degrees F.

25. Packaged produce, comprising whole head de-cored produce.

26. The packaged produce according to claim 25, wherein the packaged produce has been washed, dried, and packaged ready for use.

27. The packaged produce according to claim 25, wherein the packaging comprises a side loaded plastic bag.

28. The package produce according to claim 27, wherein the plastic bag includes a re-closable zipper.

29. The packaged produce according to claim 26, wherein said washed produce comprises subjecting the whole head de-cored produce to a flow of washing fluid through the de-cored end of the produce.

30. The packaged produce according to claim 26, wherein the produce was de-cored in a field where it was harvested, loaded in totes, and washed in a flow of washing fluid while in the totes.

31. The packaged produce according to claim 26, wherein the produce is spin dried in totes.

32. The packaged produce according to claim 16, wherein the produce is field loaded into totes, and washed and dried in the same field loaded totes.

33. A method, comprising the steps of:
cutting a product from a stalk from which is was grown;
removing a core from a core end of the product;
pre-washing the de-cored end of the product;
loading the de-cored product in a tote in a pre-aligned direction relative to the tote;
transporting the tote to a processing facility;
immersing the totes in a washing;
loading the tote, directly from the washing solution, without re-loading, to a spin dryer; and
drying the washed de-cored product in the tote in the spin dryer.

34. The method according to claim 33, further comprising the step of packaging the washed and dried de-cored product.

35. The method according to claim 33, wherein the washing solution comprises at least one of chilled water, chlorine, and an anti-bacterial agent.

36. The method according to claim 33, wherein:
the transport mechanism comprises a first conveyor belt; and
the method further comprises the steps of,
covering an open top end of the tote with a second conveyor belt, and
maintaining registration of the tote with the first conveyor belt by pressing it against the first conveyor belt with the second conveyor belt.

37. The method according to claim 33, wherein the transport mechanism comprises a conveyor belt having one of latches and stops configured to maintain registration of the tote with the conveyor belt.

38. The method according to claim 33, further comprising the step of spray washing ends of the product before loading in the tote.

39. The method according to claim 33, further comprising the step of spray washing ends of the product after loading in the tote.

40. The method according to claim 33, wherein said step of immersing comprises loading the tote on a transport mechanism configured to transport the tote through the washing tank.

41. The method according to claim 40, wherein the transport mechanism is configured to transport the tote into a flow of washing fluid directed at the de-cored end of the product in the tote.

42. The method according to claim 33, wherein:
the tote includes openings large enough to allow the flow of washing fluid and small enough to secure the produce in the tote; and
the flow of washing fluid has sufficient strength to cause at least some of the washing fluid to flow through the de-cored end and out a leafy end of the produce.

43. A wash device for washing cut vegetables in totes, comprising:
a wash tank; and
a transport mechanism configured to immerse totes containing cut de-cored vegetables in the wash tank.

44. The wash device according to claim 43, further comprising:
a flow device configured to cause a flow of a cleaning solution;
wherein:
the transport mechanism is configured to move the totes through the wash tank in a pre-determined alignment direction; and
the pre-determined alignment direction comprises an axial direction in which cut de-cored vegetables are to be located in the totes.

45. The wash tank according to claim 43, further comprising:
a flow device configured to cause a flow of a cleaning solution;
wherein:
the transport mechanism is configured to move the totes through the wash tank and the flow in a pre-determined alignment;
the flow of the cleaning solution comprises a first flow directed at a first side of the totes and a second flow directed at a second side of the totes as the totes pass through the wash tank;
the pre-determined alignment comprises a direction in which cut de-cored vegetables are located in the totes such that the cut de-cored ends of the vegetables face one of the first and second flows.

46. The wash tank according to claim 44, wherein the axial direction comprises an axis of the cut de-cored vegetables that is parallel to the flow of liquid, and the de-cored end of the vegetables facing the flow of liquid.

47. The wash tank according to claim 46, wherein the liquid comprises a chilled anti-bacterial solution.

48. The wash tank according to claim 46, wherein the wash tank comprises a dual chamber wash tank with at least one chamber containing a chilled anti-bacterial solution.

49. The wash tank according to claim 48, wherein:
the cut de-cored vegetables comprise leafy vegetables where the de-cored end of the vegetables face toward the flow of the liquid;
the leafy end of the vegetables face away from the flow of the liquid; and
the flow of liquid comprises a flow through the vegetable.

50. The wash tank according to claim 49, wherein the totes comprise slotted totes that allow the flow of liquid to be sufficient to open the leafy vegetables but not allow the vegetables to be forced out of the totes.

51. The tank according to claim 49, wherein the totes are slotted totes and a rate of the flow of liquid is maintained by the flow device at a rate sufficient to open the leafy vegetables but not allow the vegetables to be forced out of the totes.

52. The wash tank according to claim 46, wherein the liquid comprises a chilled anti-bacterial solution.

53. The wash tank according to claim 52, wherein the vegetables comprise vegetables loaded in totes in a field where they are harvested.

54. The wash tank according to claim 52, wherein the vegetables comprise vegetables, that are cut, de-cored, and loaded into totes in a field where they are harvested.

55. The wash tank according to claim 52, wherein the vegetables comprise vegetables, that are cut, de-cored, pre-washed, and loaded into totes in a field where they are harvested.

56. The wash tank according to claim 52, wherein the cut vegetables comprise vegetables, that are cut, de-cored, pre-washed, loaded into totes, and spray washed on at least one end of the vegetables in a field where they are harvested.

57. The wash tank according to claim 56, wherein the spray wash comprises a chlorine wash solution.

58. The wash tank according to claim 46, further comprising a filter set up to filter the liquid.

59. The wash tank according to claim 46, further comprising a liquid monitor configured to report on conditions of the liquid.

60. The wash tank according to claim 44, wherein the transport mechanism comprises a conveyor means having stops configured to hold the totes.

61. The wash tank according to claim 44, wherein the transport mechanism comprises a conveyor belt having one of stops configured to secure the totes and latch devices configured to secure the totes.

62. The wash tank according to claim 44, wherein the transport mechanism comprises a first conveyor device configured to move the totes through the wash tank; and
a securing device configured to move with the totes and at least one of maintain a position of the totes on the first conveyor, secure a top of the totes, and help move the totes through the wash tank.

63. The wash tank according to claim 44, wherein the transport mechanism comprises a dual conveyor belt comprising a bottom belt for supporting the totes and a top belt for securing the totes.

64. The wash tank according to claim 63, wherein the conveyor belts run in a direction perpendicular to the flow of liquid, and the pre-determined alignment direction is parallel to the flow of liquid.

65. The wash tank according to claim 64, wherein the vegetables are de-cored and an axial direction in which the vegetables are to be located in the totes comprises the de-cored end of the vegetables facing the flow of the liquid.
